(19) United States
(12) Patent Application Publication
(10) Pub. No.: US 2019/0353985 A1
(43) Pub. Date: Nov. 21, 2019

(54) UNDERWATER FISHING CAMERA, SMART FISHING CAMERA SYSTEM, AND SYSTEMS AND METHODS FOR AUTOMATIC IMAGE ROTATION AND STABILIZATION

(71) Applicant: GOFISH CAM, INC., Austin, TX (US)

(72) Inventors: Brandon Austin, Austin, TX (US); Ryan Austin, Austin, TX (US); Benjamin Derek Litteral, Austin, TX (US); Kieran Howlett, Houston, TX (US); Ron Paul Prosise, Austin, TX (US); Daniel Caputo, Austin, TX (US)

(21) Appl. No.: 16/319,457

(22) PCT Filed: Jul. 21, 2017
(86) PCT No.: PCT/US2017/043399

§ 371 Date: Jan. 21, 2019

Related U.S. Application Data
(60) Provisional application No. 62/365,254, filed on Jul. 21, 2016.
(60) Provisional application No. 62/365,277, filed on Jul. 21, 2016.
(60) Provisional application No. 62/365,269, filed on Jul. 21, 2016.
(60) Provisional application No. 62/365,237, filed on Jul. 21, 2016.

(51) Int. Cl. G03B 17/08; A01K 97/12; H04N 5/225; H04N 5/232; G06T 7/20; G06T 3/60; G06T 11/00

(52) U.S. Cl. CPC G03B 17/08; A01K 97/125; H04N 5/2252; H04W 84/12; G06T 7/20; G06T 3/60; G06T 11/00; H04N 5/23258

(57) ABSTRACT

An underwater fishing camera includes a housing having a first proximal end and a second distal end. A nose cap is fastened to the first proximal end of the housing where the nose cap and the housing form a water tight connection. A camera cap is fastened to the rear distal end of the housing where the camera cap and the housing form a water tight connection. An image and video recording device is disposed within the housing towards the second distal end. A leader line connection is connected to the housing. The leader line connection has a first connection point to connect to fishing line extending to a fishing rod and a second connection point to connect to leader line extending towards a lure or fish attractant.

### CROSS-REFERENCE TO RELATED APPLICATIONS

This application claims priority to U.S. Provisional Application No. 62/365,254 which was filed on Jul. 21, 2016; U.S. Provisional Application No. 62/365,277 which was filed on Jul. 21, 2016; U.S. Provisional Application No. 62/365,269 which was filed on Jul. 21, 2016; and U.S. Provisional Application No. 62/365,237 which was filed on Jul. 21, 2016, the contents each of which are incorporated by reference.

### BACKGROUND

### 1. Field

The disclosed embodiments relate to cameras. More specifically, the disclosed embodiments relate to underwater fishing cameras.

### 2. Related Art

Digital cameras and mobile phones have allowed people to image and record more life events than ever before. Social media websites further facilitate sharing such images and videos with family, friends, or to develop an online following. In addition to cameras readily accessible for everyday pictures and videos, several types of action cameras have also become popular. Such cameras may be mounted to a person's helmet, vehicle, ski-pole, or drone to capture a user performing various activities, such as mountain biking, skiing, snow-boarding, hiking, climbing, swimming, etc. These cameras are built to be rugged and to withstand the elements.

Another hobby that many outdoorsmen enjoy is fishing. Fishermen also enjoy sharing images and videos of fishing. However, such images and videos are limited to scenes on or near the shore or boat. Accordingly, there is a desire for cameras that can capture more fishing activity, even away from the shore or boat.

### SUMMARY

Accordingly, embodiments of an underwater fishing camera and method for taking video and photos of fishing activities, and more specifically for taking videos and photos of on-the-line fishing activities, have been developed. The camera comprises a waterproof, high definition camera capable of taking high quality videos and pictures. The waterproof housing can be securely affixed to a fishing line and film underwater close up to the lure so that the user can watch when a fish hits the lure.

This waterproof camera housing is intended to give users an underwater view when fishing or trolling. The captured footage allows users to study the behavior of the fish, while also having the ability to share the footage and experience with others. The field of application may be recreational or for scientific purposes such as study of marine biology.

One embodiment is a compact video camera built into a secure, waterproof housing that can withstand wide temperature ranges, high pressure underwater as well as traumatic impact. In one embodiment, there is a stainless-steel connection feature that runs along the length of the housing where a fishing line can be connected at each end. Furthermore, there may be two anchor points on the product, one at the front and one at the rear where the user can clip or tie on any type of line. The device can either be securely anchored or held in hand for filming and picture taking as a regular camera. Footage can be obtained live via wired or wireless connectivity, or by way of an onboard memory card. The housing allows both Wi-Fi and Bluetooth signals to pass through the wall sections without distortion to a mobile application so that the camera does not need to be removed from the water-proof housing while in-use. This way the footage can be easily uploaded through Wi-Fi or mobile data connections.

In one exemplary embodiment, an underwater fishing camera includes a housing having a first proximal end and a second distal end. A nose cap is fastened to the first proximal end of the housing where the nose cap and the housing form a water tight connection. A camera cap is fastened to the rear distal end of the housing where the camera cap and the housing form a water tight connection. An image and video recording device is disposed within the housing towards the second distal end. A leader line connection is connected to the housing. The leader line connection has a first connection point to connect to fishing line extending to a fishing rod and a second connection point to connect to leader line extending towards a lure or fish attractant.

The leader line connection may be made of metal and may be attached to the housing via a vertical fin. The leader line connection may extend from the vertical fin to the first connection and the second connection. Rubber stoppers may be disposed on the leader line connection between the vertical fin and the first connection point and between the vertical fin and the second connection point where the rubber stoppers abut against the housing. The first and second connection points may be formed as eyelets.

In some embodiments, lateral fins extend from the housing. The lateral fins may be disposed to be on one side of a plane defined by a center cross-section of the housing extending from the first end to the second end. The lateral fins are angled to push to camera slightly downward when moving through the water.

The nose cap may be formed to have an ovoidal shaped end. A charging port and one or more input devices are accessible on the housing when the nose cap is removed.

The camera may further include a Wi-Fi transceiver, a Bluetooth transceiver, a memory, and a processor disposed in the housing. The processor may operate to cause the camera to determine whether the Bluetooth transceiver is in connection range of a paired mobile device. When it is determined that the Bluetooth transceiver is not in the connection range, the camera deactivates the Wi-Fi transceiver, for example to preserve battery life. When it is determined that the Bluetooth transceiver is in the connection range, the camera connects to the paired mobile device via the Bluetooth transceiver and activates the Wi-Fi transceiver. The camera sends Wi-Fi connection instructions to the paired mobile device via the Bluetooth transceiver to connect to and transmit data to and from the mobile device.

The underwater fishing may also include one or more sensors. The underwater fishing camera associates image or video data obtained by the image and video recording device with data obtained by the one or more sensors. The one or more sensors may include at least one an accelerometer, a gyroscope, a thermostat, a pressure sensor, and a pH sensor.

In another embodiment, a method for image stabilization and anti-rotation is provided. The method includes obtaining first image or video data with a camera, obtaining first sensor data from at least one of an accelerometer and gyroscope, and establishing a baseline camera orientation based on the first image or video data and the first sensor data. The method then monitors second image or video data and second sensor data, and compares the second image or video data and the second sensor data to a predetermined threshold value. When the second image or video data or the second sensor data exceeds the predetermined threshold value, movement in the second image or video data is measured against the baseline camera orientation, and the second image or video data is moved or rotated to match the baseline camera orientation.

The baseline orientation may be established at least in part with a reference marker from the camera overlaid on the first image or video data. The reference marker may be disposed on a lens of the camera or may be a virtual marker overlaid on the first image or video data.

In yet another embodiment, a method for connecting a camera to an external device is provided. The camera has a Wi-Fi transceiver and a Bluetooth transceiver, and the method includes determining whether the Bluetooth transceiver is in connection range of a paired external device. When it is determined that the Bluetooth transceiver is not in the connection range, the camera deactivates the Wi-Fi transceiver. When it is determined that the Bluetooth transceiver is in the connection range, the camera connects to the paired external device via the Bluetooth transceiver, activates the Wi-Fi transceiver, and sends Wi-Fi connection instructions to the paired mobile device via the Bluetooth transceiver.

The Wi-Fi connection instructions may include a Wi-Fi device name of the camera. The method may further include connecting to the paired external device with the Wi-Fi transceiver.

### BRIEF DESCRIPTION OF THE DRAWINGS

FIG. 1 shows a perspective view of an underwater camera, according to an exemplary embodiment.

FIG. 2 shows an exploded view of the underwater camera of FIG. 1.

FIG. 3 shows a schematic of an underwater fishing camera, according to an exemplary embodiment.

FIG. 4 shows a housing of the underwater camera of FIG. 1.

FIG. 5 illustrates a method of controlling a Wi-Fi transceiver on a camera, according to one exemplary embodiment.

FIG. 6 shows a process for image stabilization and anti-rotation, according to an exemplary embodiment.

FIGS. 7A and 7B show camera inputs and image outputs for an image stabilization and anti-rotation system, according to one exemplary embodiment.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

Disclosed herein are embodiments of systems and methods for a camera, such as an underwater fishing camera. An underwater fishing camera as described herein has several features and advantages.

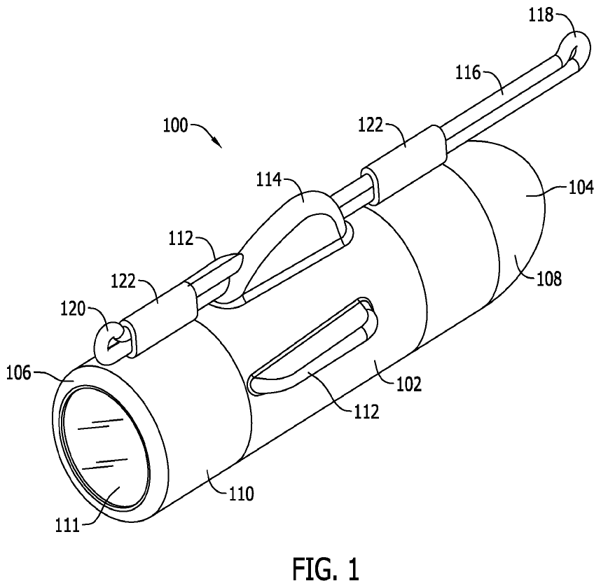

FIG. 1 shows a perspective view of an underwater camera, according to an exemplary embodiment. An underwater fishing camera 100 comprises a camera housing 102. The camera housing 102 comprises a cylindrical shape having a first end 104 and a second end 106. On the first end 104 of the housing 102 is a nose cap 108. In this embodiment, the nose cap has an ovoidal shape towards the first end. The nose cap is fastened to the housing 102 in a waterproof manner as will be described in more detail below. On the second end 106 of the housing 102 is a camera cap 110. The camera cap is also fastened to the housing 102 in a waterproof manner and includes a transparent window 111 facing the second end 106. The camera housing 102, nose cap 108, and camera cap 110 may be comprised of any suitable material providing sufficient strength and resilience. In one embodiment, polypropylene is used.

The underwater fishing camera 100 comprises lateral fins 112 extending from each side of the housing 112. The fins 112 are disposed to be on one side of a plane defined by a center cross-section of the housing 102 extending from the first end to the second end. The fins 112 are also slightly tilted. This tends to push the camera 100 slightly downward as well as to stabilize the camera 100 when the camera 100 moves through the water.

A vertical fin 114 extends upward between the later fins 112. The vertical fin 114 secures a metal leader line 116 which serves as a fishing line connection point. The metal leader line 116 includes a first connection 118 that connects a fishing line to a fishing rod of the user, and a second connection 120 that connects to a lure or other fish attractant. The first and second connection 118, 120 are formed as eyelets to facilitate fishing line passing therethrough to connect to the rod and the fishing lure. When the camera 100 is attached in this manner, the camera travels in a direction of the first end 104. The first end 104 may thus be considered the proximal end and the second end 106 may be considered the distal end.

Rubber stoppers 122 are provided on the leader line 116 and surround the leader line 116 adjacent to the first and second connections 118, 120. The rubber stoppers 122 prevent tangling of the fishing line. For example, the rubber stoppers 122 prevent the fishing line from coming between the camera housing 102 and the leader line 116 when the user casts the camera 100 and lure into the water.

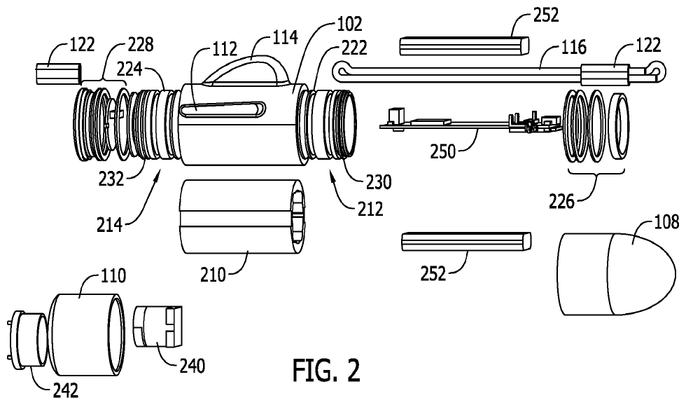

FIG. 2 shows an exploded view of the underwater fishing camera of FIG. 1. To give the housing sufficient strength to withstand deep, underwater pressure, a ribbed, cylindrical support member 210 is provided. The housing 102 is overmolded on the support member 210 to form the housing 102. The housing comprises a first threaded attachment 212 for attaching to the nose cap 108 and a second threaded attachment 214 for attaching to the end cap.

The first and second threaded attachments 212, 214 include annular grooves 222, 224 in which o-rings 226, 228 are placed to form a seal between the housing 102 and the nose cap 108 and camera cap 110. The first and second threaded attachments 212, 214 also include threads 230, 232 for fastening the nose cap 108 and camera cap 110.

The underwater fishing camera 100 further comprises a camera 240 disposed within the second end 106 of the housing 102. The camera 240 is fixed into position by a bracket 242. The bracket 242 may also comprise one or more light emitting devices such as an LED. The LED may emit visible light, such as a green colored light, to light a subject of the camera underwater. The light emitted may also be infrared, or any other desired light.

The housing 102 protects and supports a circuit board comprising a processor 250. Batteries 252 are also disposed within the housing 102 to power the various electronic components such as the camera 240, LED, and processor 250.

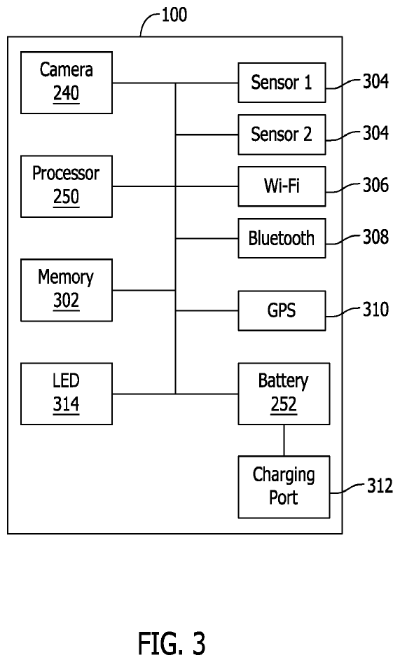

FIG. 3 shows a schematic of an underwater fishing camera, according to an exemplary embodiment. As mentioned above, the camera 100 comprises a processor 250. The processor may be any suitable control unit now known or later developed. The processor is connected with the camera to receive image information from the camera for storage on a memory 302. The camera 240 may be a digital camera having a digital light sensor such as a CMOS or CCD sensor to capture image and video data. The memory 302 may include a built-in memory such as flash storage, a hard drive, etc. The memory may also comprise removable media such as an SD card. The processor further receives information from a plurality of sensors 304. Such sensors may include accelerometers, barometers, pressure sensors, thermostats, gyroscopes, and the like. Such sensors may be built in to obtain information regarding the operating state of the camera 100 or to obtain information about the environment of the camera.

In one embodiment, the camera 100 is equipped with a Wi-Fi transceiver 306. The Wi-Fi transceiver is configured to connect to a remote device, such as a mobile phone, computer, or a network connected router to send image data stored in the memory and/or to receive software or firmware updates from a network. A Bluetooth transceiver 308 is also provided for electronic data transfer and to control the Wi-Fi connection as will be described in more detail below. In another embodiment, a GPS receiver 310 may be provided to calculate a current location of the camera 100. As mentioned above, the camera 100 houses a battery 252. The battery 252 is charged by a charging port 312 which may be a micro-usb, usb-c, or any other standard or proprietary connection.

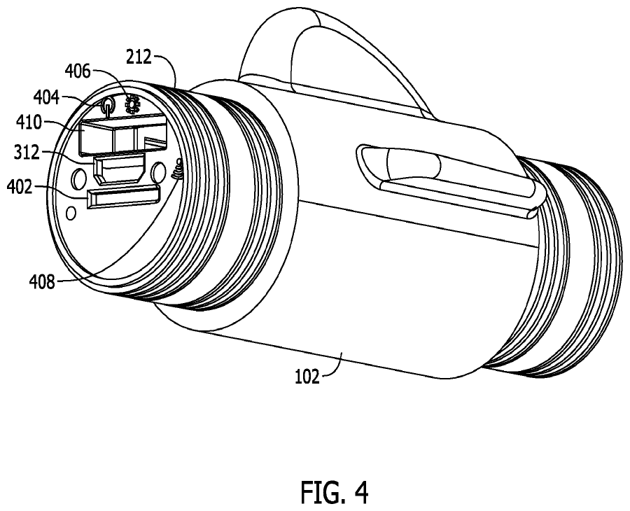

FIG. 4 shows a housing of the underwater camera of FIG. 1. As shown in FIG. 4, with the nose cap removed, the user may access the controls and/or ports of the camera. For example, the charging port 312 may be disposed on the end of the housing 102 along with a slot 402 for an SD card. Power button 410 may be operated to control power as indicated by power indicator 404, LED lights as shown by indicator 406, and Wi-Fi as shown by indicator 408 with the nose cap removed. This control and other input devices, buttons, ports, etc. may be included as necessary.

Other modifications of the housing are also contemplated. For example, with the threaded attachments 212, 214 of the housing 102, interchangeable nose caps and camera caps may be provided for different applications and control of the camera, and to provide added features.

For example, different camera caps and nose caps are provided with different weights, to generate different sounds when traveling through the water, to have different buoyancy and shape variation, etc.

In one embodiment of a nose cap, a nose cap may be connected on the external surface by a tether to a flotation transmitter. The flotation transmitter will float on the surface of the body of water with the camera below so that the inside of the nose cap may utilize a transmitter to communicate signal from the user above the surface to the Bluetooth and Wi-Fi integrated on-board into the camera module and may provide a real-time stream of video data through the wire to the surfaced floatation device so the user may be able to connect, view and interact with the underwater device via the mobile application. The tether sensor can be used for many other sensor and communication applications. There may be alternative wire options with similar real-time underwater communication application where the wire from the underwater fishing camera is tethered directly to the fishing boat or the angler's location instead of a floatation, bobber-like surface transmitter. The direct tether wire may be used for boat, pier and surf fishing among other fishing or underwater activities.

In another embodiment of an underwater fishing camera, the exterior profile of the nose cap may be shaped in various fluid mechanical head designs for different applications for various underwater environments when submerged and moved in water. The interchangeable nose cap sizes and shapes may be short, long, blunt, round, bullet or conical profile nose caps to adjust for variable head velocities when the device is stationary or transient movement in the water.

The interchangeable nose caps may also be composed in variable density materials to allow adjustable weight and buoyancy of the device in the fresh and saltwater environments. In this case the nose cap may act as a sinker weight or floater or have adjustable weight system that assist in positioning the camera view angle.

One embodiment of a nose cap may also include a built-in bait dispenser for attracting different species of fish to the lure. In one instance, as the underwater camera device travels through the water, the nose cap contains a mechanism that releases bait or bait smell with respect to time or movement to attract fish. In a similar application, the nose cap may have an external design that generates an underwater noise in a mechanical sense, such as humming or whistle that mimics the sound of bait fish or other fish attractant sounds to lure fish intended to catch. The nose cap may conceal an electronic sound device, fish call, or physical-like rattle to create noise to simulate bait fish attractant. In another embodiment, the nose cap may have a pass-through line feature to allow the option for anglers to not use a leader line.

The camera cap may include options with different lens color filters to allow different fish cues and imaging affects. Alternative camera caps may be with different lighting arrays: LED, IR, different types of lighting colors or types. In other embodiments, the camera cap may include lens options such as zoom, wide versus narrow perspective, and adjustment of camera angle.

While the nose cap and the end cap are shown to be screwed on via the threads in the described embodiments, other connection methods are also contemplated. Such may include a press fit, quick-connects, adhesive fit, etc. The nose cap and camera cap may come in various colors as desired by the user or manufacturer that may aid in attracting fish.

In another embodiment, the nose cap may have mounting options for non-fishing application. The nose cap may have a clip, magnet, strap or other attachment feature to mount to other surfaces such as boat railings, hats, rods, and other structures for non-fishing camera uses.

In some embodiments, the length of the line leader 116 may be variable and adjustable for stability purposes depending on the weight and hydrodynamics of the lure. The length of the line leader 116 on the side of the first connection 118 may be longer, shorter, or same size as the side of the second connection 120.

The line leader shape and profile may also be adjustable to enhance camera stability and orientation while the camera is being pulled through the water. In one embodiment, the leader may be designed for different mounting systems to hook into the leader. The mounting systems include gyro-stability mounts, handle held camera strap, pole hook mounts. In one embodiment, the line leader allows an easy clip on swivel and auto alignment with triangular shape mount design. The line leader can be constructed as one solid piece for added strength when in tension. This concept is accomplished with a double-bend symmetry line leader design.

In use, it is generally recommended that the fishing line connected from the nose end leader of the line connector to the fisherman will be higher tensile strength line than the line connected from the camera end leader of the line connector to the lure/bait hook so that when a fish is caught, or the hook is snagged on an object, the line between the hook and the camera end line leader will break before the other line so that the camera may not be lost underwater.

### Bluetooth and Wi-Fi Integration

As mentioned above, the camera 100 comprises Bluetooth and Wi-Fi transceivers for data transmission to an external device. Bluetooth connections are convenient for ease of connection and for lower power consumption. Wi-Fi transceivers are known for higher rates of data transmission, but tend to consume more battery life. With the described underwater camera, connection to a remote device is generally impossible when the camera is submerged underwater. Thus, it is important to be able to control the Wi-Fi transceiver to conserve battery when the camera does not need to connect to a remote device.

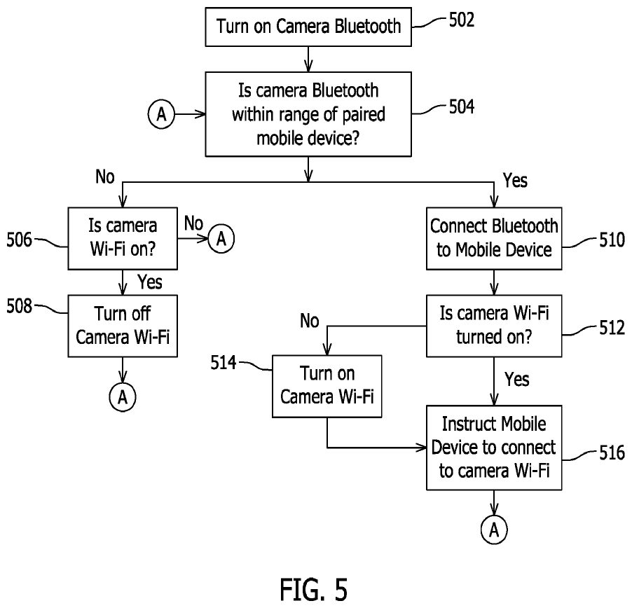

FIG. 5 illustrates a method of controlling a Wi-Fi transceiver on a camera, according to one exemplary embodiment. It is noted that the method illustrated in FIG. 5 is not only applicable to the described underwater camera, but may also be applied to digital cameras generally.

In step 502, the processor of a camera turns on a Bluetooth transceiver. For example, software instructions stored on a memory 302 of the camera 100 are executed by the processor 250 which cause the processor to activate the Bluetooth transceiver 308. In step 504, the processor determines whether a paired remote device is in range of the camera. The processor receives data from the Bluetooth connector to determine whether one of previously paired devices stored in the memory is available to initiate a Bluetooth connection.

When there is no paired device within range, the process proceeds to step 506. For example, when an underwater camera is submerged, it is quickly no longer within the range of a mobile device of a user above the surface, such as on the shore or in a boat. In step 506, the processor determines whether a Wi-Fi transceiver of the camera is on. If the Wi-Fi transceiver is off, then the process returns to step 504. If the Wi-Fi transceiver is on, then the camera turns off the Wi-Fi transceiver in step 508. The process then returns to step 504. In this manner, when the camera is not in range of a mobile device, the camera saves battery power by turning of the Wi-Fi transceiver. This increases the time during which the camera can capture image and video data.

In step 504, when the camera is in range of a mobile device, the processor initiates a Bluetooth connection with the mobile device in step 510. Once connected, the camera determines whether the camera Wi-Fi transceiver is turned in in step 512. If the Wi-Fi transceiver is not turned on, then the camera turns on the Wi-Fi transceiver in step 514 and proceeds to step 516. If the camera determines the Wi-Fi transceiver is on in step 512, then the process proceeds directly to step 516. In step 516, the camera sends an indication through the Bluetooth connection to the mobile device to connect with the camera via a Wi-Fi connection. This may be done via an application on the mobile device of a user. With the connection established, the method returns to step 504.

In this manner, the battery life of the camera can be preserved by only turning on the Wi-Fi transceiver when needed. The low-power, Bluetooth transceiver is used to determine whether the Wi-Fi transceiver should be enabled, and the Wi-Fi transceiver is only enabled to perform high speed data transfer with a remote device when it is determined the remote device is within range.

As another advantage, the speed of connection to a mobile device or other Wi-Fi enabled device is increased. If there are multiple Wi-Fi networks showing in a location, the Bluetooth connection will serve as a direct identification tool of the camera Wi-Fi network for the mobile device with the camera's mobile application to quickly connect. This can be controlled by an application so the user does not need to select the correct Wi-Fi connection from among a list of available connections in a settings menu of a mobile device.

### Image Stabilization and Anti-Rotation

With the underwater camera described above, the underwater camera may experience turbulence due to rough water conditions, being cast from a rod, trolling through water, action from a fish, or reeling-in action from a user. Thus, an image or video captured by the camera may have undesired movement or rotation due to the movement of the camera at the end of the fishing line in the water. Furthermore, in other camera applications there may be unwanted movement in the image. This may be true of “action” cameras, drone mounted cameras, or simply from an unsteady hand of a person filming with the camera.

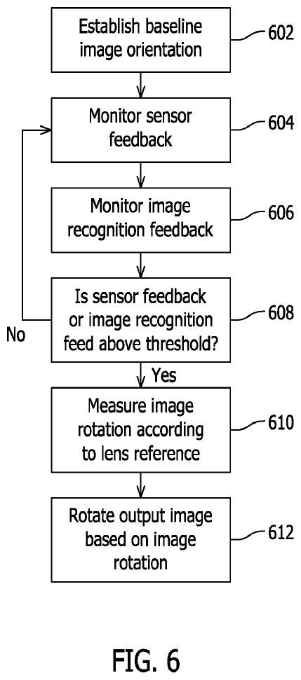

Accordingly, a method and system has been developed to counter act this camera motion to output a stable image or video. FIG. 6 shows a process for image stabilization and anti-rotation, according to an exemplary embodiment. In step 602, a baseline image orientation is established for the camera. The baseline image may be detected both by sensor data and by an image output. For example, gyroscopic and accelerometer sensors may indicate that the camera is level and relatively stationary. Image recognition software analyzing pixels of an image obtained by the camera may detect no large changes in components of the captured image.

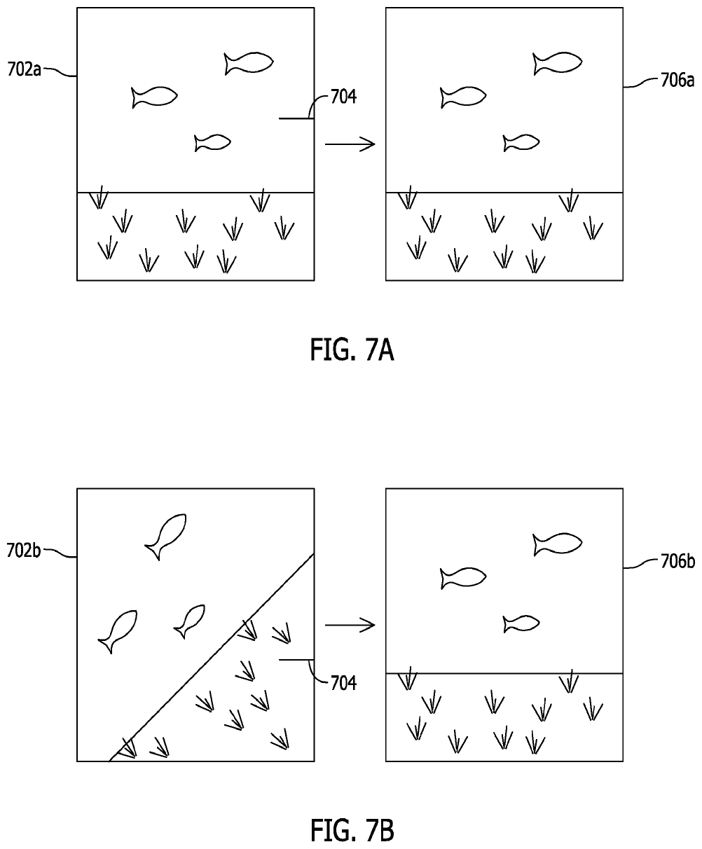

FIGS. 7A and 7B show camera inputs and image outputs for an image stabilization and anti-rotation system, according to one exemplary embodiment. As shown in FIG. 7A, an image 702 is captured by a camera. The camera has a lens that includes a reference marker 704 to aid in image stabilization and anti-rotation. Because the image 702a is the baseline image for the camera, the output image 706a is similar to the captured image 702a.

Returning to FIG. 6, in step 604, the camera monitors sensor feedback information. Such sensors may include accelerometer data and gyroscope data which together detect movement and orientation of the camera. In step 606, the camera also monitors the captured images and video, such as by using image recognition, to monitor movement of image features in the image. This monitoring may be with reference to the lens reference marker 704 (FIGS. 7A and 7B).

When the feedback information exceeds a predetermined threshold as shown in step 608, the camera determines the image has rotated in an undesirable manner, or that the image has become unstable. The process then proceeds to set 610. However, so long as the feedback remains below the threshold in step 608, the camera continues to monitor the feed in steps 604 and 606.

In step 610, the rotation of the image or other image distortions due to camera movement are measured. This is done at least in part by analyzing the image movement compared with the lens reference. This also may be combined with gyroscope and accelerometer data to determine to what degree the image has moved or rated from a baseline orientation. In step 612, the output image is rotated or moved back to the baseline based on the amount of rotation or movement determined in step 610. In the example shown in FIG. 7B, a captured image 702b has rotated due to camera movement caused by a pull on the fishing line, a fish striking the lure, water turbulence, etc. Based on the amount of rotation detected in the image using the lens reference marker 704, an output image 706b is adjusted back to the baseline orientation.

In some embodiments, a processor of the camera may implement the stabilization anti-rotation features described above. In other embodiments, a device with an automatic video editing application will receive the data from the camera along with the image and/or video data to apply the stabilization and anti-rotation features. In the above described embodiments, the reference marker 704 was integrated on a lens. In some embodiments, the reference marker 704 may implemented on the camera cap or may be a virtual marker via software.

### Smart Camera Features

The above described camera may also incorporate several other features by way of the sensor information obtained on the camera, via an associated mobile device, and the like. As explained above, the camera may include several sensors that measure not only camera activity such as camera position, movement, speed, and orientation, but also measure environmental conditions such as water temperature, water pressure, pH level, salinity, oxygen levels, and the like. Further, data obtained from the camera may be associated with other available data such as a time of day, time of year, moon cycle, weather data, tide data, reservoir level/capacity data, etc. Other information may be obtained via image recognition such as water clarity, plant species, fish and other animal species, terrain, etc. All of these factors and inputs may aid to enable other features on the camera or on applications or databases associated with the camera.

In one example, the underwater fishing camera may be configured to estimate a path taken through the water, such as during trolling or other fishing activity. The camera may have a GPS sensor that obtains an initial GPS position prior to the camera being submerged and losing GPS signals. The camera then measures gyroscope and acceleration data to estimate a path through the water. Upon returning to the surface, the camera obtains an ending GPS position, and interpolates the path of the camera between the initial and ending GPS positions. This allows the camera or computing device to mark significant events along the path. For example, positions along the path where fish were recognized, where fish approached a lure or other fish attractant, or where fish struck the lure or fish attractant may be mapped and identified. This may help an angler in future fishing activity, such as to slow or increase trolling speed, to focus on a certain fishing area, etc.

In another example locations of fish within the water, fish activity level, fish sizes, species types, and fish strikes may be correlated with environmental data such as time of day, time of year, water depth, pH level, water temperature, location, etc. This data may be collected through an application for multiple anglers using the camera system to develop a database of fish activity. This database may be analyzed to predict future fishing activity at various locations to aid anglers in predicting the best times and places at which to fish. The database may also aid wildlife managers and environmental researchers to better understand fish behavior and to study the effects of different environmental factors on fish or other underwater life.

To save battery life and/or memory storage, the camera may use motion sensors such as sonar to determine whether any fish or other objects are within a field of view of the camera. The camera may be set to record only when such movement is present. In this way, the battery is preserved and storage on a memory card is conserved to ensure that the camera records only when there is something interesting within the field of view.

The smart underwater camera system may aid in mapping the floor bottom to create a map of the underwater environment through a mobile application. The mapping feature may be used for scuba divers, boatmen, fishermen, marine biologists and scientists for various purposes. For underwater fishing video capture, the topology will provide an additional frame of reference for the underwater fishing experience i.e. augmented reality of the underwater world from a wider scope of reference in parallel with the video taken when catching a fish.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An underwater fishing camera comprising:
a housing having a first proximal end and a second distal end;
a nose cap fastened to the first proximal end of the housing, the nose cap and the housing forming a water tight connection;
a camera cap fastened to the rear distal end of the housing, the camera cap and the housing forming a water tight connection;
an image and video recording device disposed within the housing towards the second distal end; and
a leader line connection connected to the housing, the leader line connection comprising a first connection point to connect to fishing line extending to a fishing rod and a second connection point to connect to leader line extending towards a lure or fish attractant.

2. The underwater fishing camera of claim 1, wherein the leader line connection is comprised of metal and is attached to the housing via a vertical fin, the leader line connection extending from the vertical fin to the first connection and the second connection.

3. The underwater fishing camera of claim 2, further comprising rubber stoppers disposed on the leader line connection between the vertical fin and the first connection point and between the vertical fin and the second connection point, the rubber stoppers abutting against the housing.

4. The underwater fishing camera of claim 1, wherein the first connection point comprises an eyelet and the second connection point comprises an eyelet.

5. The underwater fishing camera of claim 1, comprising lateral fins extending from the housing.

6. The underwater fishing camera of claim 5, wherein the lateral fins are disposed to be on one side of a plane defined by a center cross-section of the housing extending from the first end to the second end.

7. The underwater fishing camera of claim 5, wherein the lateral fins are angled to push to camera downward when moving through the water.

8. The underwater fishing camera of claim 1, wherein the nose cap comprises an ovoidal shaped end.

9. The underwater fishing camera of claim 8, wherein a charging port and one or more input devices are accessible on the housing when the nose cap is removed.

10. The underwater fishing camera of claim 1, further comprising a Wi-Fi transceiver, a Bluetooth transceiver, a memory, and a processor disposed in the housing, the processor configured to execute machine readable instructions stored on the memory which when executed cause the camera to:
determine whether the Bluetooth transceiver is in connection range of a paired mobile device;
when it is determined that the Bluetooth transceiver is not in the connection range, deactivate the Wi-Fi transceiver of the camera;
when it is determined that the Bluetooth transceiver is in the connection range,
connect to the paired mobile device via the Bluetooth transceiver;
activate the Wi-Fi transceiver of the camera; and
send Wi-Fi connection instructions to the paired mobile device via the Bluetooth transceiver.

11. The underwater fishing camera of claim 1, further comprising one or more sensors wherein the underwater fishing camera associates image or video data obtained by the image and video recording device with data obtained by the one or more sensors.

12. The underwater fishing camera of claim 11, wherein the one or more sensors comprises at least one an accelerometer, a gyroscope, a thermostat, a pressure sensor, and a pH sensor.

13. A method for image stabilization and anti-rotation, the method comprising:
obtaining first image or video data with a camera;
obtaining first sensor data from at least one of an accelerometer and gyroscope;
establishing a baseline camera orientation based on the first image or video data and the first sensor data;
monitoring second image or video data and second sensor data and comparing the second image or video data and the second sensor data to a predetermined threshold value; and
when the second image or video data or the second sensor data exceeds the predetermined threshold value,
measuring movement in the second image or video data against the baseline camera orientation, and
moving or rotating the second image or video data to match the baseline camera orientation.

14. The method according to claim 13, wherein the baseline orientation is established at least in part with a reference marker from the camera overlaid on the first image or video data.

15. The method according to claim 14, wherein the reference marker is disposed on a lens of the camera.

16. The method according to claim 14, wherein the reference marker is a virtual marker overlaid on the first image or video data.

17. A method for connecting a camera to an external device, the camera comprising a Wi-Fi transceiver and a Bluetooth transceiver, the method comprising:
determining whether the Bluetooth transceiver is in connection range of a paired external device;
when it is determined that the Bluetooth transceiver is not in the connection range, deactivating the Wi-Fi transceiver of the camera;
when it is determined that the Bluetooth transceiver is in the connection range,
connecting to the paired external device via the Bluetooth transceiver;
activating the Wi-Fi transceiver of the camera; and
sending Wi-Fi connection instructions to the paired mobile device via the Bluetooth transceiver.

18. The method according to claim 17, wherein the Wi-Fi connection instructions comprise a Wi-Fi device name of the camera.

19. The method according to claim 18, further comprising connecting to the paired external device with the Wi-Fi transceiver.
